(19) United States
(12) Patent Application Publication
(10) Pub. No.: US 2026/0246340 A1
(43) Pub. Date: Aug. 20, 2026

(54) ELECTRIC DRIVE DEVICE

(71) Applicant: HONDA MOTOR CO., LTD., Tokyo (JP)

(72) Inventor: Teppei MATSUMOTO, Saitama (JP)

(21) Appl. No.: 19/380,345

(22) Filed: Nov. 5, 2025

(30) Foreign Application Priority Data
Feb. 20, 2025 (JP) 2025-026220

(51) Int. Cl. H02K 9/19; H02K 5/20; H02K 7/00; H02K 7/116

(52) U.S. Cl. CPC H02K 9/19; H02K 5/203; H02K 7/003; H02K 7/006; H02K 7/116

(57) ABSTRACT

An electric drive device includes an electric motor including a drive unit that drives a rotation shaft, and a transmission mechanism connected to one end side of the rotation shaft and to a drive shaft, and transmits an output torque. A first helical passage and a second helical passage are formed on the rotation shaft. The first helical passage includes a first inlet formed between the transmission mechanism and the drive unit, and a first outlet formed on the other end side, and feeds a lubricating oil that has flowed into the first inlet to the first outlet. The second helical passage includes a second inlet formed on the other end side of the rotation shaft and a second outlet formed in the connected portion connected to the transmission mechanism, and feeds the lubricating oil that has flowed into the second inlet to the second outlet.

### TECHNICAL FIELD

The present invention relates to an electric drive device comprising an electric motor that drives a rotation shaft, a drive shaft, and a transmission mechanism that transmits an output torque of the electric motor from the rotation shaft to the drive shaft.

### BACKGROUND ART

In recent years, efforts to realize a low-carbon or carbon-free society have been gaining momentum, and research and development of electrification technologies is being conducted for vehicles, aircraft, and the like to reduce CO2 emissions and improve energy efficiency.

In the aircraft, an electric drive device including an electric motor and a transmission mechanism (reduction gear) is employed to rotate a rotor. There is a demand for the electric drive device to be compact. On the other hand, in the electric drive device, since the electric motor and the transmission mechanism generate heat, the electric drive device needs to be cooled. In a case where a cooling device is provided in the electric drive device, the size of the electric drive device increases due to the cooling device. Accordingly, there is a technique for cooling the electric drive device while suppressing the increase in size of the electric drive device. For example, JP2024-126692A discloses a propulsion force generator including a reduction gear in the form of a planetary gear mechanism and an electric motor connected to the planetary gear mechanism. A rotation shaft of the planetary gear mechanism is provided with a helical groove that functions as a pump, and a lubricating oil is stored inside a case of the planetary gear mechanism. The lubricating oil is fed through the helical grooves formed on the rotation shaft and flows inside of the planetary gear mechanism. Accordingly, it is possible to cool the electric drive device while suppressing the increase in size of the electric drive device.

JP2024-126692A does not disclose cooling of the electric motor in the propulsion force generator.

### SUMMARY OF THE INVENTION

In view of the above background, an object of the present invention is to provide an electric drive device including an electric motor and a transmission mechanism, and capable of achieving both cooling and compactness of the electric motor and the transmission mechanism. This in turn contributes to improving energy efficiency.

To achieve such an object, one aspect of the present invention provides an electric drive device including: an electric motor including a rotation shaft and a drive unit configured to drive the rotation shaft; a drive shaft; a transmission mechanism connected to one end side of the rotation shaft and to the drive shaft and configured to transmit an output torque of the electric motor from the rotation shaft to the drive shaft; a case; and a lubricating oil passage provided in the case and through which lubricating oil flows. The rotation shaft includes: a first shaft formed in a hollow tubular shape extending in an axial direction of the rotation shaft and connected to the drive unit at a position closer to the other end side of the rotation shaft than the transmission mechanism; and a second shaft inserted inside the first shaft, arranged coaxially with the first shaft, including a connected portion connected to the transmission mechanism at the one end side, and configured to rotate together with the first shaft. The lubricating oil passage includes: a first helical passage formed in the first shaft and extending helically about a rotation axis of the rotation shaft; and a second helical passage formed in the second shaft and extending helically about the rotation axis of the rotation shaft. The first helical passage includes, in the first shaft, a first inlet formed between the transmission mechanism and the drive unit, and a first outlet formed on the other end side, and is configured to feed the lubricating oil that has flowed into the first inlet according to rotation of the first shaft to the first outlet. The second helical passage includes a second inlet formed on the other end side of the rotation shaft and a second outlet formed in the connected portion, and is configured to feed the lubricating oil that has flowed into the second inlet according to the rotation of the second shaft to the second outlet.

According to this aspect, the second outlet of the second helical passage is provided in the connected portion connected to the transmission mechanism. Accordingly, the lubricating oil flowing out from the second outlet can lubricate and cool the transmission mechanism. Further, since the first helical passage is formed on the first shaft of the rotation shaft connected to the drive unit of the electric motor, the heat transferred from the drive unit of the electric motor to the first shaft is cooled by the lubricating oil flowing through the first helical passage. Accordingly, the lubricating oil flowing through the first helical passage can cool the drive unit of the electric motor. Further, since the first helical passage and the second helical passage are formed on the rotation shaft, the lubricating oil passage can be made compact. Accordingly, the electric drive device can lubricate the transmission mechanism and cool the electric motor using the compact lubricating oil passages. Accordingly, the electric drive device includes the electric motor and the transmission mechanism, and can achieve both cooling and compactness of the electric motor and the transmission mechanism.

Thus, according to the above aspects, it is possible to provide the electric drive device including the electric motor and the transmission mechanism, and capable of achieving both cooling and compactness of the electric motor and the transmission mechanism.

### BRIEF DESCRIPTION OF THE DRAWINGS

FIG. 1 is a perspective view of an aircraft according to an embodiment;

FIG. 2 is a perspective view of a base and an electric drive device;

FIG. 3 is a cross-sectional view of the electric drive device;

FIG. 4 is a perspective view of a bottom wall portion of a case;

FIG. 5 is a perspective view of a rotation shaft;

FIG. 6 is an exploded perspective view of the rotation shaft;

FIG. 7 is a cross-sectional view taken along line VII-VII of FIG. 3;

FIG. 8 is a cross-sectional view taken along line VIII-VIII of FIG. 3;

FIG. 9 is a cross-sectional view taken along line IX-IX of FIG. 3;

FIG. 10 is a cross-sectional view taken along line X-X of FIG. 3; and

FIG. 11 is a perspective view of a transmission mechanism.

### DETAILED DESCRIPTION OF THE INVENTION

In the following, an aircraft 1 according to an embodiment of the present invention will be described with reference to the drawings. In the drawings and the following description, directions such as forward, rearward, left, right, up, and down are directions defined relative to the aircraft 1.

### the aircraft 1

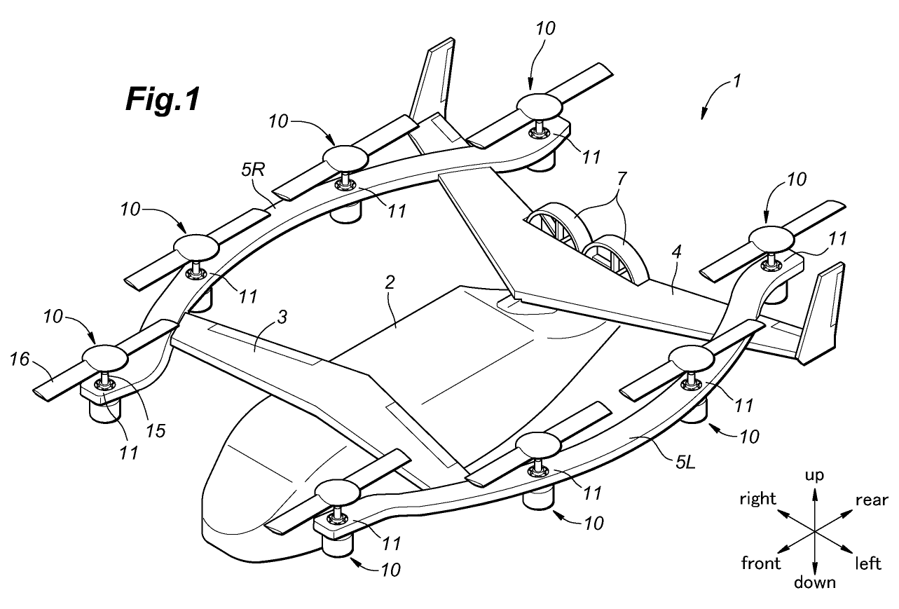

FIG. 1 is a perspective view showing the aircraft 1 according to the embodiment of the present invention. As shown in FIG. 1, the aircraft 1 is an electric vertical take-off and landing aircraft (eVTOL aircraft) capable of taking off and landing vertically. The aircraft 1 includes a body 2 extending in the front-and-rear direction, a front wing 3 extending in the lateral direction and connected to the front portion of the body 2, a rear wing 4 extending in the lateral direction and connected to the rear portion of the body 2, a left arm 5L extending in the front-and-rear direction and connecting the left end of the front wing 3 to the left side portion of the rear wing 4, and a right arm 5R extending in the front-and-rear direction and connecting the right end of the front wing 3 to the right side portion of the rear wing 4. The front wing 3 and the rear wing 4 are formed in a shape that generates lifting force when moving forward.

A cabin (not shown) for an occupant to board is provided in the front portion of the body 2. Left and right rear propulsion force generators 7 for applying the forward propulsion force to the aircraft 1 are provided at the rear end of the body 2.

The left arm 5L and the right arm 5R are each provided with a plurality of (for example, four) electric drive devices 10 at intervals in the front-and-rear direction. Each electric drive device 10 applies ascending and descending forces to the aircraft 1. The left arm 5L and the right arm 5R are provided with a plurality of bases 11, each provided with an electric drive device 10.

Each base 11 has the same configuration. Further, each electric drive device 10 has the same configuration. One electric drive device 10 will be described below.

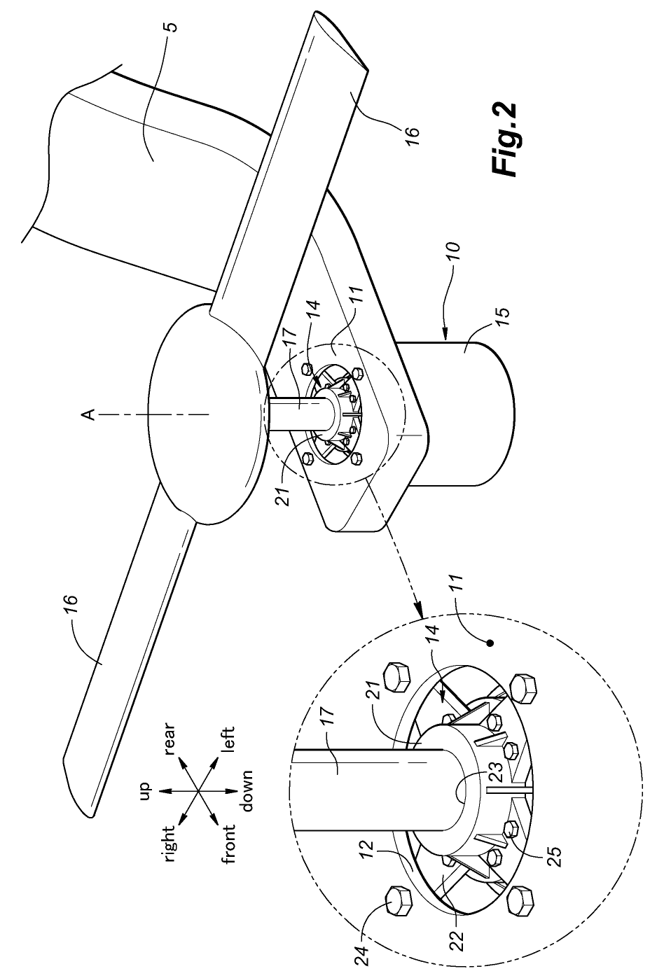

FIG. 2 is a perspective view of the base 11 and the electric drive device 10. As shown in FIG. 2, the bases 11 are provided on the left arm 5L and the right arm 5R, and formed in a plate shape. The base 11 includes an attachment hole 12 extending in the up-and-down direction. The attachment hole 12 is a circular hole. A support portion 14 is removably attached to the base 11. The electric drive device 10 is attached to the base 11 via the support portion 14.

Each electric drive device 10 includes a case 15 and a drive shaft 17 extending in the up-and-down direction and having a rotor 16 fixed to the upper end (one end) thereof.

The support portion 14 includes a tubular main body 21 that rotatably supports the drive shaft 17, and four arm portions 22 that extend radially outward from the main body 21. The main body 21 is formed in a cylindrical shape that extends in the up-and-down direction. The main body 21 is provided with a bearing hole 23 extending vertically through the center thereof. The bearing hole 23 is provided with the bearing (not shown). The drive shaft 17 is rotatably supported in the bearing hole 23 via the bearing.

Four arm portions 22 extend radially from the lower end of the main body 21. Each arm portion 22 is connected to the main body 21. Each arm portion 22 is fastened to the base 11 by the fastener 24, such as a bolt and nut. Accordingly, the main body 21 is supported by the base 11 via a plurality of arm portions 22. Each arm portion 22 is fastened to the case 15 by a fastener 25, such as a bolt and nut. Accordingly, the electric drive device 10 is fixed to the base 11 via the arm portion 22. Each electric drive device 10 rotates the rotor 16 together with the drive shaft 17 to apply the ascending and descending forces to the aircraft 1.

### the electric drive device 10

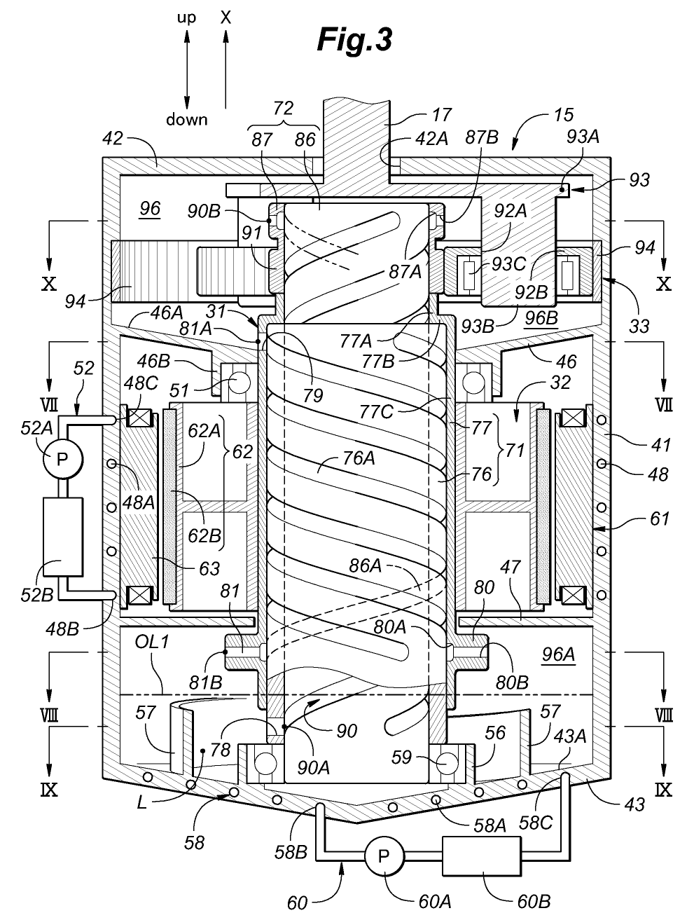

FIG. 3 is a cross-sectional view of the electric drive device 10. As shown in FIG. 3, the electric drive device 10 includes the case 15, the drive shaft 17 extending in the up-and-down direction and having the rotor 16 (not shown in FIG. 3) fixed to the upper end (one end) side thereof and, an electric motor 32 including a rotation shaft 31, and a transmission mechanism 33 connected to the rotation shaft 31 and the drive shaft 17 and transmitting the output torque of the electric motor 32 from the rotation shaft 31 to the drive shaft 17. The drive shaft 17 and the rotation shaft 31 are arranged coaxially. The direction in which the rotation axis of the drive shaft 17 and the rotation shaft 31 extends is defined as an axial direction X. The axial direction X is the up-and-down direction.

The case 15 includes a cylindrical circumferential wall portion 41 extending in the axial direction X, an upper wall portion 42 connected to the upper end of the circumferential wall portion 41, and a bottom wall portion 43 connected to the lower end of the circumferential wall portion 41. The case 15 accommodates the electric motor 32 and the transmission mechanism 33. The electric motor 32 is arranged below the transmission mechanism 33.

The circumferential wall portion 41 includes a partition wall portion 46 and a partition wall portion 47 formed in the shape of plates and protruding radially inward, and a first cooling passage 48 formed therein. The rotation shaft 31 is inserted through the partition wall portion 46 and the partition wall portion 47.

The partition wall portion 46 is arranged between the electric motor 32 and the transmission mechanism 33 and inclines downward toward the radially inner side. An upper surface 46A of the partition wall portion 46 inclines downward toward the radially inner side. A bearing 51 that rotatably supports the rotation shaft 31 is provided below the radially inner end of the partition wall portion 46. The partition wall portion 46 includes a tubular cylindrical wall portion 46B that extends downward around the outer circumference of the bearing 51. The bearing 51 is supported by the lower surface of the radially inner end of the partition wall portion 46 and the cylindrical wall portion 46B. The bearing 51 is preferably a bearing capable of supporting the radial load and the axial load. The bearing 51 may be, for example, a tapered roller bearing or an angular contact ball bearing.

The partition wall portion 47 is formed in the shape of a plate that protrudes radially inward below the electric motor 32. The radially inner end of the partition wall portion 47 and the rotation shaft 31 are spaced apart.

The first cooling passage 48 includes a helical passage 48A extending helically about the rotation axis of the rotation shaft 31 on the outer circumference of the electric motor 32, an inlet 48B extending radially outward from the lower end of the helical passage 48A, and an outlet 48C extending radially outward from the upper end of the helical passage 48A. A refrigerant (for example, water) in liquid form flows through the first cooling passage 48. The inlet 48B and the outlet 48C of the first cooling passage 48 are connected to an external passage 52. The external passage 52 is attached to the outside of the case 15. The external passage 52 is provided with a pump 52A for pumping the refrigerant and a heat exchanger 52B. The refrigerant flowing through the first cooling passage 48 is pumped by the pump 52A and cools the electric motor 32.

The upper wall portion 42 is formed in a disk-like shape having a surface facing the up-and-down direction. The upper wall portion 42 closes the upper opening of the circumferential wall portion 41. The upper wall portion 42 includes a through hole 42A extending in the up-and-down direction. The drive shaft 17 is inserted through the through hole 42A. A bearing capable of supporting the radial load, such as a ball bearing or a sliding bearing, may be provided between the through hole 42A and the drive shaft 17.

The bottom wall portion 43 is connected to the lower end of the circumferential wall portion 41 and is formed into a conical plate shape the diameter of which increases upward. The bottom wall portion 43 closes the lower opening of the circumferential wall portion 41. The upper surface of the bottom wall portion 43 includes an inclined surface 43A that inclines downward toward the radially inner side.

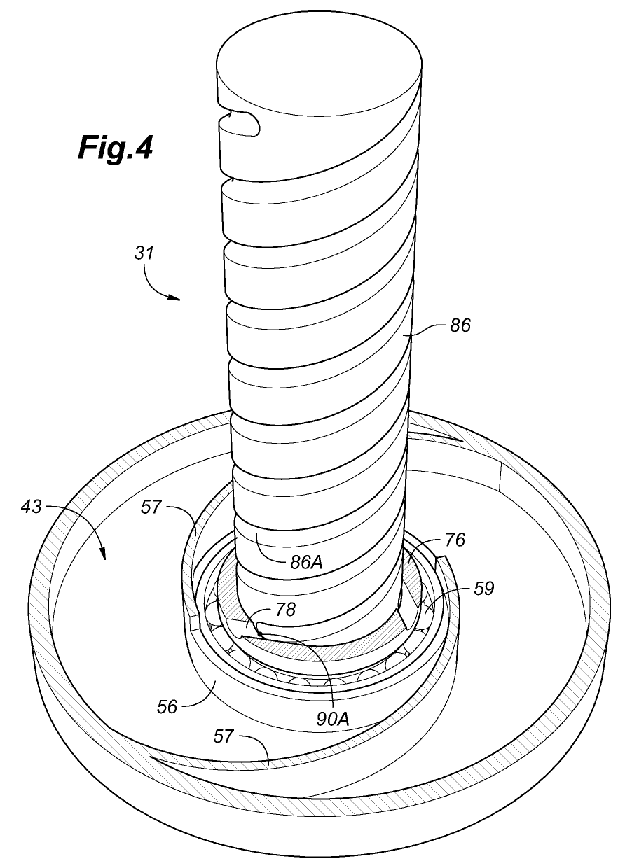

FIG. 4 is a perspective view of the bottom wall portion 43 of the case 15. As shown in FIG. 4, the bottom wall portion 43 includes a cylindrical wall 56 that extends upward around the outer circumference of the rotation shaft 31, a plurality of helical raised walls 57 that extend upward and helically radially outward from the outer circumference of the rotation shaft 31 about the rotation axis, and a second cooling passage 58 (see FIG. 3) formed therein. A plurality of helical raised walls 57 extends helically from the cylindrical wall 56 radially outward of the rotation axis.

A bearing 59 that supports the rotation shaft 31 is provided between the cylindrical wall 56 and the lower end of the rotation shaft 31. As shown in FIG. 3, the bearing 59 is supported by the inclined surface 43A of the bottom wall portion 43 and the cylindrical wall 56. The bearing 59 may be capable of supporting the radial load and the axial load. The bearing 51 may be, for example, a tapered roller bearing or an angular contact ball bearing.

The second cooling passage 58 includes, inside the bottom wall portion 43, the helical passage 58A extending helically about the rotation axis of the rotation shaft 31 from the outer circumference of the rotation shaft 31 radially outward of the rotation axis, an inlet 58B extending downward from one end of the helical passage 58A, and the outlet 58C extending downward from the other end of the helical passage 58A. The refrigerant (for example, water) in liquid form flows through the second cooling passage 58. The inlet 58B and the outlet 58C of the second cooling passage 58 are connected to an external passage 60. The external passage 60 is attached to the outside of the case 15. The external passage 60 is provided with a pump 60A for pumping the refrigerant and a heat exchanger 60B. The refrigerant flowing through the second cooling passage 58 cools the bottom wall portion 43.

The electric motor 32 includes the rotation shaft 31 extending in the axial direction X and a drive unit 61 that drives the rotation shaft 31. The drive unit 61 includes a rotor 62 formed integrally with the rotation shaft 31, and a stator 63 that faces the rotor 62 at an interval on the outer circumference of the rotor 62.

The rotor 62 includes a cylindrical rotor core 62A extending in the axial direction X, and a plurality of permanent magnets 62B fixed to the outer circumference of the rotor core 62A. The inner circumferential surface of the rotor core 62A is connected to the outer circumferential surface of the rotation shaft 31.

The stator 63 is fixed to the inner circumferential surface of the circumferential wall portion 41 and includes a plurality of coils (not shown). The magnetic force of the plurality of permanent magnets 62B of the rotor 62 and the magnetic force of the plurality of coils of the stator 63 generate the output torque that rotates the rotor 62 and the rotation shaft 31 about the axis of the rotation shaft 31.

### the rotation shaft 31

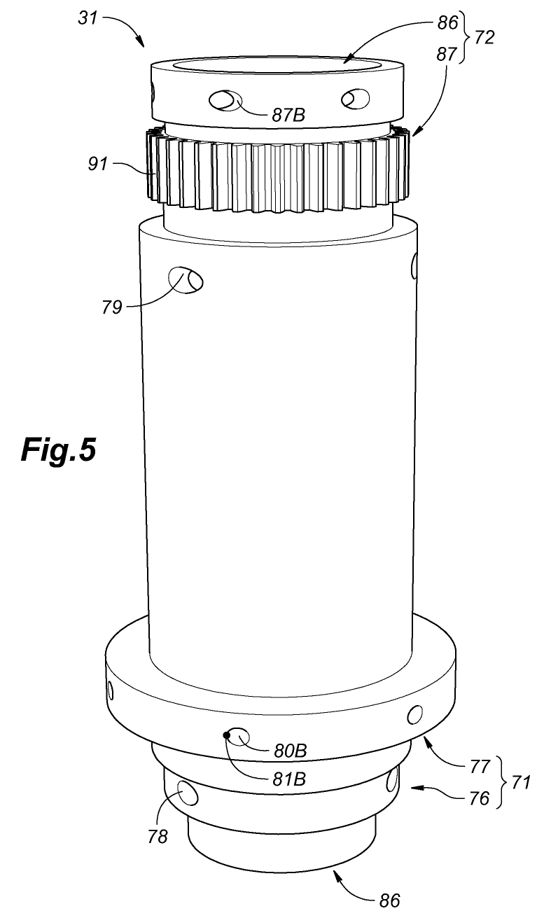

FIG. 5 is a perspective view of the rotation shaft 31. As shown in FIGS. 3 and 5, the rotation shaft 31 includes a first shaft 71 formed in a hollow tubular shape extending in the axial direction X, and a second shaft 72 extending in the axial direction X and is inserted inside the first shaft 71. The first shaft 71 and the second shaft 72 are arranged coaxially and coupled to each other. Further, the first shaft 71 rotates together with the second shaft 72. As shown in FIG. 3, the first shaft 71 is coupled to the rotor 62 (rotor core 62A) of the drive unit 61 at a position closer to the lower end (the other end) side of the rotation shaft 31 than the transmission mechanism 33.

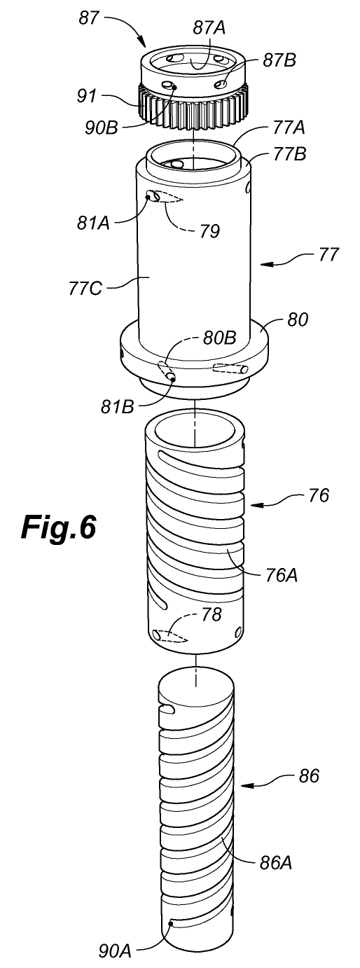

FIG. 6 is an exploded perspective view of the rotation shaft 31. As shown in FIGS. 5 and 6, the first shaft 71 includes an inner tubular portion 76 formed in a hollow tubular shape extending in the axial direction X, and an outer tubular portion 77 formed in a hollow tubular shape extending in the axial direction X and through which the inner tubular portion 76 is inserted. The inner tubular portion 76 and the outer tubular portion 77 are coupled to each other.

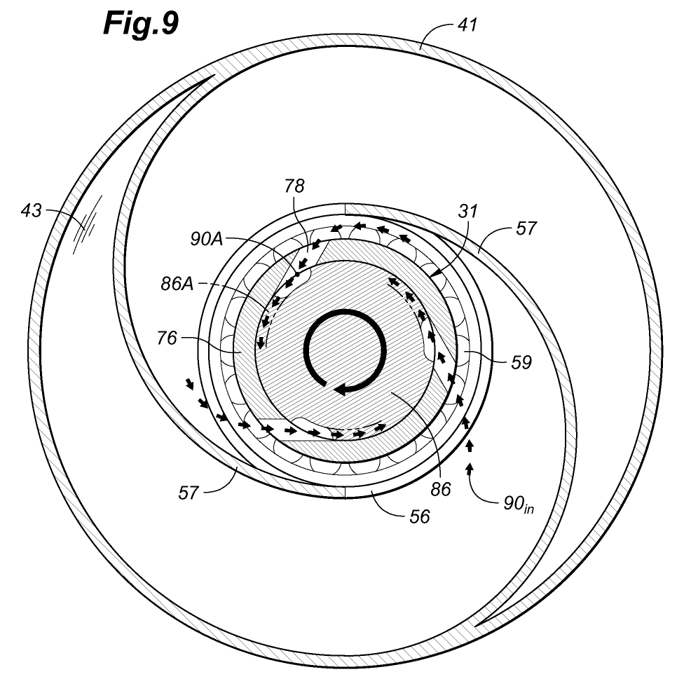

As shown in FIG. 6, three first helical grooves 76A, each extending helically in a left-handed direction about the rotation axis of the rotation shaft 31 in the up-and-down direction, are provided on the outer circumferential surface of the inner tubular portion 76. The inner tubular portion 76 is provided with three through holes 78 (see FIG. 9) extending in the radial direction on the lower side of the first helical groove 76A.

The outer tubular portion 77 includes the first outer tubular portion 77A at the upper end, the shoulder 77B extending radially outward from the lower end of the first outer tubular portion 77A, and the second outer tubular portion 77C extending downward from the shoulder 77B. The outer diameter of the first outer tubular portion 77A is smaller than the outer diameter of the second outer tubular portion 77C. As shown in FIG. 3, the inner tubular portion 76 is arranged below the shoulder 77B and on the inner circumference of the second outer tubular portion 77C.

The second outer tubular portion 77C is coupled to the rotor 62 (rotor core 62A). As shown in FIGS. 3 and 6, the upper portion of the second outer tubular portion 77C is provided with three through holes 79 corresponding to the upper end of each of the three first helical grooves 76A of the inner tubular portion 76. The lower portion of the second outer tubular portion 77C is provided with a protruding portion 80 that protrudes radially outward around the entire circumference of the second outer tubular portion 77C.

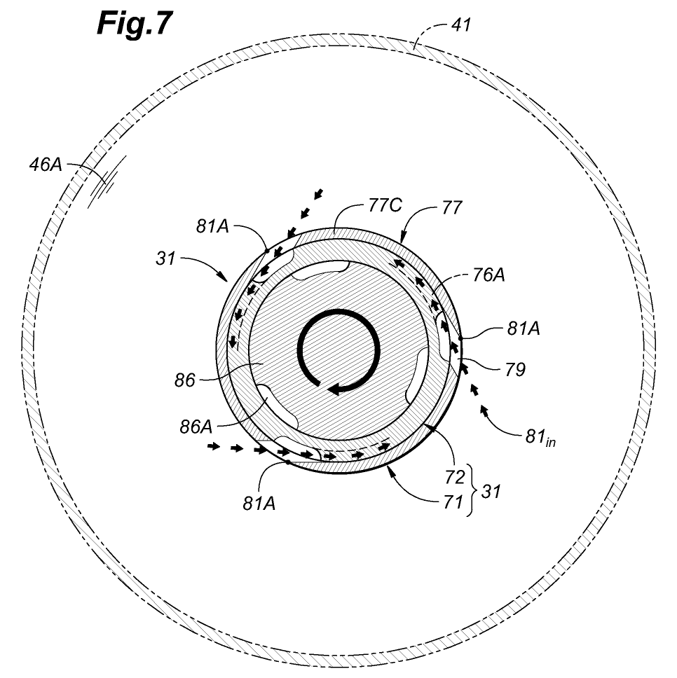

FIG. 7 is a cross-sectional view taken along line VII-VII of FIG. 3. As shown in FIG. 7, each of the three through holes 79 extends in the tangential direction of the upper end of the first helical groove 76A of the inner tubular portion 76.

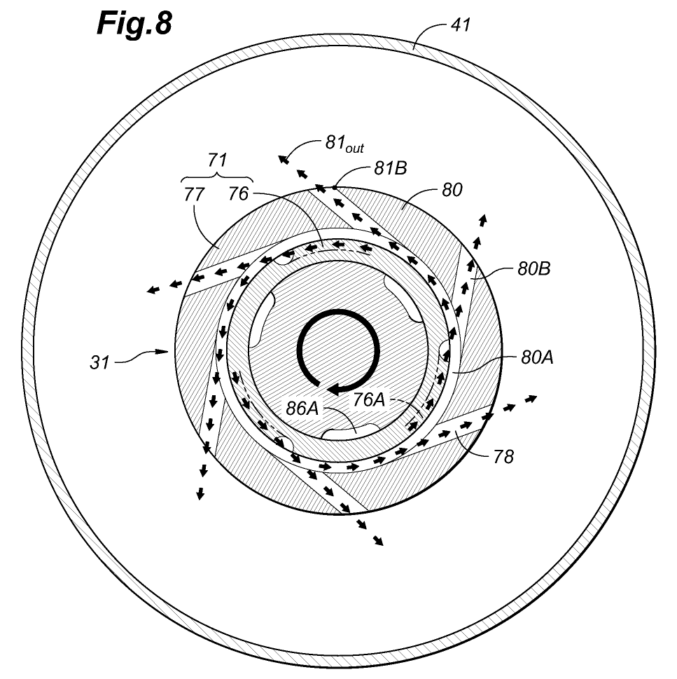

FIG. 8 is a cross-sectional view taken along line VIII-VIII of FIG. 3. As shown in FIGS. 3 and 8, the protruding portion 80 is provided with an annular groove 80A recessed radially outward from the inner circumferential surface around the entire circumference, and six through holes 80B (see FIG. 7) extending outward in the tangential direction from the annular groove 80A.

The annular groove 80A corresponds to the lower end of each of the three first helical grooves 76A. As shown in FIG. 8, six through holes 80B are provided at equal intervals in the circumferential direction of the protruding portion 80 and extend in the tangential direction. Three of the six through holes 80B each extend in the tangential direction of the lower end of the first helical groove 76A of the inner tubular portion 76.

As shown in FIGS. 3 and 6, the first shaft 71 includes a first helical passage 81, through which lubricating oil L flows, formed by the three first helical grooves 76A of the inner tubular portion 76, and the three through holes 79, the annular groove 80A, and six through holes 80B of the outer tubular portion 77.

The first helical passage 81 extends helically in the left-handed direction (one of a right-handed direction and a left-handed direction) about the rotation axis of the rotation shaft 31 in the axial direction X. In the first helical passage 81, each of the three through holes 79 of the second outer tubular portion 77C serves as a first inlet 81A, and the six through holes 80B of the protruding portion 80 serve as a first outlet 81B. The first inlet 81A is formed between the transmission mechanism 33 and the drive unit 61, and the first outlet 81B is formed on the lower end (the other end) side of the first shaft 71. The first helical passage 81 is formed to extend helically in the left-handed direction so as to feed the lubricating oil L that has flowed into the first inlet 81A according to the rotation of the first shaft 71 to the first outlet 81B.

As shown in FIGS. 3, 5 and 6, the second shaft 72 includes a cylindrical portion 86 formed in a cylindrical shape extending in the axial direction X, and a connected portion 87 formed in a cylindrical shape and connected to the outer circumference of the upper end of the cylindrical portion 86. The cylindrical portion 86 is inserted inside the inner tubular portion 76 (first shaft 71). The cylindrical portion 86 and the inner tubular portion 76 are coupled to each other. Further, the connected portion 87 and the outer tubular portion 77 (upper end of the first outer tubular portion 77A) are coupled to each other.

As shown in FIG. 6, the outer circumferential surface of the cylindrical portion 86 is provided with three second helical grooves 86A that extend helically in the left-handed direction about the rotation axis of the rotation shaft 31 in the up-and-down direction.

FIG. 9 is a cross-sectional view taken along line IX-IX of FIG. 3. As shown in FIG. 9, the lower ends of the three second helical grooves 86A correspond to the three through holes 78 of the inner tubular portion 76, respectively. Each of the three through holes 78 of the inner tubular portion 76 extends in the tangential direction of the lower end of the second helical groove 86A.

As shown in FIGS. 3 and 6, a portion of the transmission mechanism 33 (a sun gear 91 described later) is formed in the connected portion 87. Accordingly, the connected portion 87 is coupled to the transmission mechanism 33.

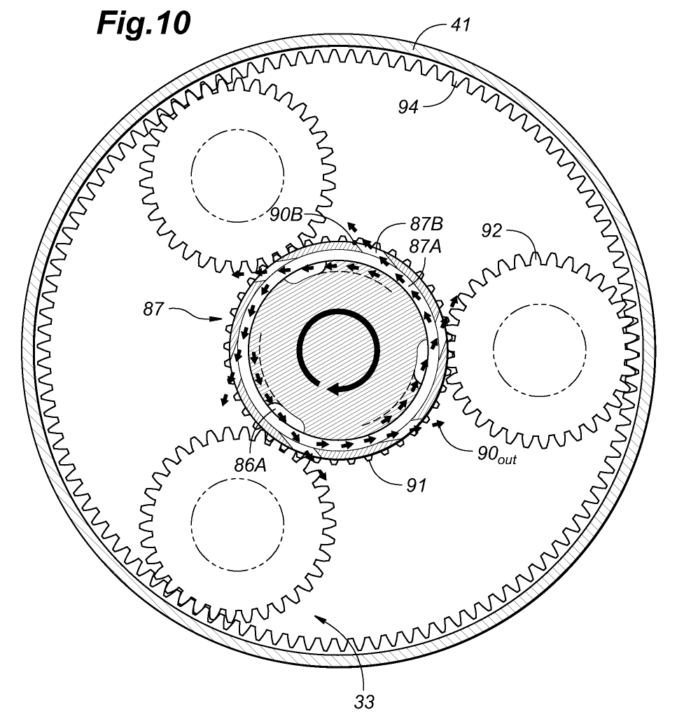

FIG. 10 is a cross-sectional view taken along line X-X of FIG. 3. As shown in FIGS. 3 and 10, the connected portion 87 is provided with an annular groove 87A recessed radially outward around the entire circumference, and six through holes 87B extending radially outward from the annular groove 87A. The annular groove 87A corresponds to the upper end of the second helical groove 86A of the cylindrical portion 86. The six through holes 87B are provided at equal intervals in the circumferential direction and extend in the tangential direction. Three of the six through holes 87B each extend in the tangential direction of the upper end of the second helical groove 86A of the cylindrical portion 86.

As shown in FIGS. 3 and 6, the second shaft 72 includes a second helical passage 90, through which the lubricating oil L flows, formed by the three second helical grooves 86A of the cylindrical portion 86, and the annular groove 87A and six through holes 87B of the connected portion 87.

The second helical passage 90 extends helically in the right-handed direction (the other of the right-handed direction and the left-handed direction) about the rotation axis of the rotation shaft 31 in the axial direction X. In the second helical passage 90, the lower ends of the three second helical grooves 86A of the cylindrical portion 86 serve as a second inlet 90A, and each of the six through holes 87B of the connected portion 87 serves as a second outlet 90B. In the second shaft 72, the second inlet 90A is formed on the lower end (the other end) side of the rotation shaft 31. The second outlet 90B is formed in the connected portion 87. The second helical passage 90 is formed to extend helically in the right-handed direction so as to feed the lubricating oil L that has flowed into the second inlet 90A according to the rotation of the second shaft 72 to the second outlet 90B.

### the transmission mechanism 33

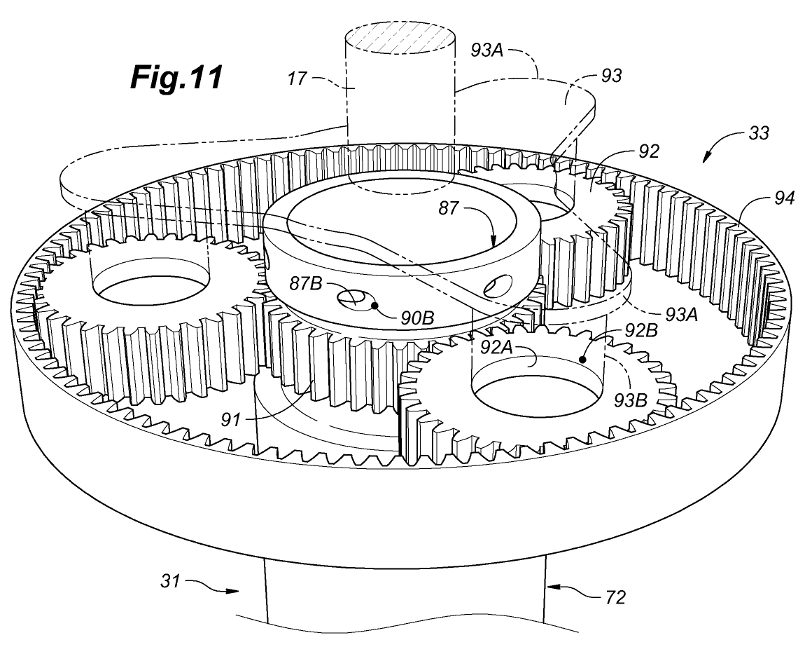

FIG. 11 is a perspective view of the transmission mechanism 33. As shown in FIG. 11, the transmission mechanism 33 is a planetary gear mechanism that includes the sun gear 91 provided on the outer circumference of the connected portion 87 of the second shaft 72, three planetary gears 92 meshed with the sun gear 91, a planetary carrier 93 rotatably supporting the three planetary gears 92, and a ring gear 94 meshed with the three planetary gears 92. There is no limitation on the number of planetary gears 92. For example, the number of planetary gears 92 may be four.

The sun gear 91 is a spur gear coaxial with the rotation shaft 31. The sun gear 91 is integrally formed with the connected portion 87 of the rotation shaft 31.

Each planetary gear 92 is a spur gear formed in a tubular shape extending in the axial direction X. As shown in FIG. 3, each planetary gear 92 includes a through hole 92A and an annular upper wall 92B extending radially inward at the upper end. The ring gear 94 is arranged coaxially with the drive shaft 17, the rotation shaft 31, and the sun gear 91. The ring gear 94 is coupled to the inner surface of the circumferential wall portion 41 of the case 15.

As shown in FIG. 11, the planetary carrier 93 is coupled to the drive shaft 17. The planetary carrier 93 includes three radially enlarged plate portions 93A extending radially outward from the drive shaft 17, a shaft 93B extending downward from each of the three radially enlarged plate portions 93A, and a bearing 93C (see FIG. 3) coupled to the shaft 93B. As shown in FIG. 3, the shaft 93B is inserted through the through hole 92A of the planetary gear 92. The bearing 93C is provided below the upper wall 92B of the planetary gear 92. The bearing 93C is coupled to the inner circumferential surface of the through hole 92A of the planetary gear 92 and the shaft 93B. The planetary gear 92 is rotatably supported by the bearing 93C. The bearing 93C is preferably a bearing capable of supporting the radial load. The bearing 93C may be a ball bearing or a sliding bearing.

### a lubricating oil passage 96

The space provided in the case 15 through which the lubricating oil L flows is referred to as the "lubricating oil passage 96." As shown in FIG. 3, the lubricating oil passage 96 includes a first storage space 96A arranged below the partition wall portion 47 and provided on the bottom wall portion 43 side of the case 15, a second storage space 96B arranged above the partition wall portion 46, the first helical passage 81, and the second helical passage 90.

The first storage space 96A is connected to the first outlet 81B of the first helical passage 81 and the second inlet 90A of the second helical passage 90, and stores the lubricating oil L. The first outlet 81B is arranged higher than the oil level OL1 of the lubricating oil L stored in the first storage space 96A. The second inlet 90A is immersed in the lubricating oil L stored in the first storage space 96A.

The second storage space 96B is connected to the first inlet 81A of the first helical passage 81 and the second outlet 90B of the second helical passage 90, and stores the lubricating oil L. The upper surface 46A of the partition wall portion 46 inclines downward toward the radially inner side to define the second storage space 96B. The upper surface 46A of the partition wall portion 46 serves as a bottom surface that inclines downward toward the radially inner side in the second storage space 96B.

### transmission of driving force of the electric drive device 10

As shown in FIG. 11, when the rotation shaft 31 is rotated by the electric motor 32, the sun gear 91 provided on the outer circumference of the rotation shaft 31 rotates. As the sun gear 91 rotates, the three planetary gears 92 meshed with the sun gear 91 rotate about the axes and revolve around the outer circumference of the sun gear 91. Accordingly, the planetary carrier 93 rotates together with the drive shaft 17 about the axis of the drive shaft 17. Accordingly, the output torque of the rotation shaft 31 is decelerated and transmitted to the drive shaft 17. The drive shaft 17 rotates together with the rotor 16 (see FIG. 2) and applies the ascending and descending forces to the aircraft 1.

### circulation of the lubricating oil L

As will be described in detail below, the lubricating oil L flows through the lubricating oil passage 96 as follows: (1) to (4). (1) Inflow of the lubricating oil L into the second helical passage 90: when the rotation shaft 31 rotates, the lubricating oil L stored in the first storage space 96A flows into the second inlet 90A of the second helical passage 90. (2) Outflow of the lubricating oil L from the second helical passage 90: the lubricating oil L that has flowed into the second inlet 90A is fed to the second outlet 90B through the second helical passage 90, and flows out from the second outlet 90B into the second storage space 96B. The lubricating oil L is then stored in the second storage space 96B. (3) Inflow of the lubricating oil L into the first helical passage 81: the lubricating oil L stored in the second storage space 96B flows into the first inlet 81A of the first helical passage 81. (4) Outflow of the lubricating oil L from the first helical passage 81: the lubricating oil L that has flowed into the first inlet 81A is fed to the first outlet 81B through the first helical passage 81, and flows out from the first outlet 81B into the first storage space 96A.

(1) Inflow of the lubricating oil L into the second helical passage 90. As shown in FIG. 3, the second inlet 90A of the second helical passage 90 is immersed in the lubricating oil L stored in the first storage space 96A. As indicated by the arrow 90 in in FIG. 9, as the rotation shaft 31 rotates, the lubricating oil L stored in the first storage space 96A flows into the second inlet 90A of the second helical passage 90 formed in the second shaft 72. Since the second inlet 90A is immersed in the lubricating oil L stored in the first storage space 96A, the lubricating oil L readily flows into the second inlet 90A.

The helical raised walls 57 are provided around the second inlet 90A. The helical raised walls 57 prevent the lubricating oil L from flowing radially outward from the second inlet 90A. Thereby, the helical raised walls 57 can facilitate the lubricating oil L flowing into the second inlet 90A.

Further, each of the three through holes 78 extends in the tangential direction of the lower end of the second helical groove 86A. Accordingly, as indicated by the arrow 90 in in FIG. 9, the lubricating oil L can flow into the second inlet 90A from the outer circumference of the inner tubular portion 76 without significantly changing the direction thereof. Thereby, the lubricating oil L readily flows into the second inlet 90A. Accordingly, the flow rate of the lubricating oil L flowing through the second helical passage 90 can be increased.

(2) Outflow of the lubricating oil L from the second helical passage 90. As shown in FIG. 3, the second outlet 90B (through hole 87B) of the second helical passage 90 is formed in the connected portion 87 connected to the transmission mechanism 33. The second outlet 90B (through hole 87B) is arranged above the sun gear 91 of the transmission mechanism 33. As indicated by the arrow 90 out in FIG. 10, the lubricating oil L flowing out from the second outlet 90B (through hole 87B) flows toward the portion where the sun gear 91 and the planetary gear 92 mesh with each other. Accordingly, the meshing portion between the sun gear 91 and the planetary gear 92 is lubricated. The lubricating oil L is then deposited on the planetary gear 92. Further, the lubricating oil L is fed to the planetary gear 92 and deposited on the ring gear 94. Accordingly, lubrication is provided between the planetary gear 92 and the ring gear 94. The lubricating oil L that has lubricated the transmission mechanism 33 (sun gear 91, the planetary gear 92, and the ring gear 94) drips from the transmission mechanism 33 and is stored in the second storage space 96B (see FIG. 3).

As indicated by the arrow 90out in FIG. 10, the lubricating oil L that has flowed out from the upper ends of each of the three second helical grooves 86A flows through the annular groove 87A and six through holes 87B, and flows out from the six through holes 87B toward the portion where the sun gear 91 and the planetary gear 92 mesh with each other. Here, the number of through holes 87B (6) is greater than the number of second helical grooves 86A (3). By providing the annular groove 87A and the six through holes 87B, the lubricating oil L can be discharged more uniformly in the circumferential direction of the sun gear 91. This ensures that the meshing portions of the sun gear 91 and the planetary gear 92 are suitably lubricated.

Further, the second outlet 90B (through hole 87B) extends in the tangential direction of the upper end of the second helical groove 86A. Accordingly, as indicated by the arrow 90 out in FIG. 10, the lubricating oil L flows out from the second outlet 90B from the upper end of the second helical groove 86A without significantly changing the direction thereof. Thereby, the lubricating oil L readily flows out from the second outlet 90B. Accordingly, the flow rate of the lubricating oil L flowing through the second helical passage 90 can be increased.

(3) Inflow of the lubricating oil L into the first helical passage 81. As shown in FIG. 3, the first inlet 81A of the first helical passage 81 is connected to the bottom of the second storage space 96B. As indicated by the arrow 81 in in FIG. 7, the lubricating oil L stored in the second storage space 96B flows into the first helical passage 81 from the first inlet 81A and flows downward through the first helical passage 81. As shown in FIGS. 3 and 6, the first helical passage 81 (first helical groove 76A) is provided on the outer circumference of the rotation shaft 31. Accordingly, the lubricating oil L flowing through the first helical passage 81 can cool the electric motor 32 from the inside.

The bottom surface of the second storage space 96B is the upper surface 46A of the partition wall portion 46, and inclines downward toward the radially inner side. This facilitates the accumulation of the lubricating oil L on the inner side of the bottom surface of the second storage space 96B. The lubricating oil L then readily flows into the second inlet 90A arranged on the inner side of the bottom surface of the second storage space 96B.

Further, as shown in FIG. 7, each of the three through holes 79 in the outer tubular portion 77 extends in the tangential direction of the lower end of the first helical groove 76A. Accordingly, as indicated by the arrow 81 in in FIG. 7, the lubricating oil L can flow into the first helical groove 76A from the outer circumference of the outer tubular portion 77 without significantly changing the direction thereof. Thereby, the lubricating oil L readily flows into the first helical passage 81. Accordingly, the flow rate of the lubricating oil L flowing through the first helical passage 81 can be increased.

(4) Outflow of the lubricating oil L from the first helical passage 81. The lubricating oil L that has flowed through the first helical passage 81 flows out from the first outlet 81B into the first storage space 96A and is stored in the first storage space 96A. More specifically, as indicated by the arrow 81 out in FIG. 8, the lubricating oil L that has flowed out from the lower ends of the three first helical grooves 76A flows through the annular groove 80A and the six through holes 80B, and flows out from the six through holes 80B into the first storage space 96A. As shown in FIG. 3, the first outlet 81B is arranged higher than the oil level OL1 of the lubricating oil L stored in the first storage space 96A. Accordingly, the lubricating oil L flows out from the first outlet 81B more readily than when the first outlet 81B is immersed in the lubricating oil L stored in the first storage space 96A.

Next, the effects of the electric drive device 10 will be described.

The first helical passage 81 includes the first inlet 81A formed between the transmission mechanism 33 and the drive unit 61, and the first outlet 81B formed on the lower end (the other end) side, and is configured to feed the lubricating oil L that has flowed into the first inlet 81A according to the rotation of the first shaft 71 to the first outlet 81B. The second helical passage 90 includes a second inlet 90A formed on the lower end (the other end) side of the rotation shaft 31 and a second outlet 90B formed in the connected portion 87, and is configured to feed the lubricating oil L that has flowed into the second inlet 90A according to the rotation of the second shaft 72 to the second outlet 90B.

Here, the second outlet 90B of the second helical passage 90 is provided in the connected portion 87 connected to the transmission mechanism 33. Accordingly, the lubricating oil L that has flowed out from the second outlet 90B can lubricate and cool the transmission mechanism 33. Further, since the first helical passage 81 is formed on the first shaft 71 connected to the drive unit 61 of the electric motor 32, the heat transferred from the drive unit 61 of the electric motor 32 to the first shaft 71 is cooled by the lubricating oil L flowing through the first helical passage 81. Accordingly, the lubricating oil L flowing through the first helical passage 81 can cool the drive unit 61 of the electric motor 32. Further, since the first helical passage 81 and the second helical passage 90 are formed on the rotation shaft 31, the lubricating oil passage 96 can be made compact. Accordingly, the electric drive device 10 can lubricate the transmission mechanism 33 and cool the electric motor 32 using the compact lubricating oil passage 96. Accordingly, the electric drive device 10 includes the electric motor 32 and the transmission mechanism 33, and can achieve both cooling of the electric motor 32 and the transmission mechanism 33 and compactness.

Since the second inlet 90A is immersed in the lubricating oil L stored in the first storage space 96A, the lubricating oil L readily flows into the second inlet 90A. Further, the flow rate of the lubricating oil L flowing through the second helical passage 90 can be increased. Further, the flow rate of the lubricating oil L flowing through the second helical passage 90 can be increased. Accordingly, the flow rate of the lubricating oil L that flows out from the second outlet 90B and lubricates the transmission mechanism 33 increases, so that the lubricating oil L can reliably lubricate the transmission mechanism 33.

The first outlet 81B is arranged higher than the oil level OL1 of the lubricating oil L stored in the first storage space 96A and is not immersed in the lubricating oil L. Thereby, the lubricating oil L flows out from the first outlet 81B of the first helical passage 81 more readily than when the first outlet 81B is immersed in the lubricating oil L stored in the first storage space 96A. Accordingly, the flow rate of the lubricating oil L flowing through the first helical passage 81 can be increased. Accordingly, the lubricating oil L flowing through the first helical passage 81 can reliably cool the electric motor 32.

The bottom wall portion 43 of the case 15 is provided with the second cooling passage 58 (cooling passage) through which the refrigerant flows. The lubricating oil L stored in the first storage space 96A is cooled by the refrigerant flowing through the second cooling passage 58. The lubricating oil L cools the electric motor 32 and the transmission mechanism 33. Accordingly, the lubricating oil L can more reliably cool the electric motor 32 and the transmission mechanism 33.

The case 15 includes a plurality of helical raised walls 57. The helical raised walls 57 are provided around the second inlet 90A. The helical raised walls 57 prevent the lubricating oil L from flowing radially outward from the second inlet 90A. Thereby, the lubricating oil L readily flows into the second inlet 90A. Accordingly, the flow rate of the lubricating oil L flowing through the second helical passage 90 can be increased. Accordingly, the lubricating oil L can reliably lubricate and cool the transmission mechanism 33.

The first inlet 81A is immersed in the lubricating oil L stored in the second storage space 96B. Thereby, the lubricating oil L stored in the second storage space 96B readily flows into the first helical passage 81 from the first inlet 81A. Accordingly, the flow rate of the lubricating oil L flowing through the first helical passage 81 can be increased. Accordingly, the lubricating oil L flowing through the first helical passage 81 can reliably cool the electric motor 32.

The second storage space 96B is defined by a bottom surface (46A) that inclines downward toward the radially inner side. The inclined bottom surface (46A) facilitates the accumulation of the lubricating oil L stored in the second storage space 96B at the first inlet 81A arranged on the radially inner side of the second storage space 96B. Thereby, the lubricating oil L stored in the second storage space 96B readily flows into the first helical passage 81 from the first inlet 81A. Accordingly, the flow rate of the lubricating oil L flowing through the first helical passage 81 can be increased. Accordingly, the lubricating oil L flowing through the first helical passage 81 can reliably cool the electric motor 32.

The first helical passage 81 extends helically in the left-handed direction (one of the right-handed direction and left-handed direction) about the rotation axis of the rotation shaft 31. The second helical passage 90 extends helically in the right-handed direction (the other of the right-handed direction and the left-handed direction) about the rotation axis of the rotation shaft 31. Accordingly, the first helical passage 81 can be formed so that the lubricating oil L that has flowed from the first inlet 81A is reliably fed to the first outlet 81B, and the second helical passage 90 can be formed so that the lubricating oil L that has flowed from the second inlet 90A is reliably fed to the second outlet 90B.

Since the transmission mechanism 33 is the planetary gear mechanism, the length of the transmission mechanism 33 in the axial direction X can be shortened. Accordingly, the electric drive device 10 can be made compact.

The embodiment is not limited to the above configuration and can be widely modified and implemented. For example, the first helical passage 81 may extend helically in the right-handed direction (one of the right-handed direction and the left-handed direction) about the rotation axis of the rotation shaft 31, and the second helical passage 90 may extend helically in the left-handed direction (the other of the right-handed direction and the left-handed direction) about the rotation axis of the rotation shaft 31.

The above embodiments may also be described as follows.

One aspect of the present invention provides an electric drive device 10 including: an electric motor 32 including a rotation shaft 31 and a drive unit 61 configured to drive the rotation shaft 31; a drive shaft 17; and a transmission mechanism 33 connected to one end side of the rotation shaft 31 and to the drive shaft 17 and configured to transmit an output torque of the electric motor 32 from the rotation shaft 31 to the drive shaft 17; a case 15; and a lubricating oil passage 96 provided in the case 15 and through which lubricating oil L flows (circulates). The rotation shaft includes: a first shaft 71 formed in a hollow tubular shape extending in an axial direction X of the rotation shaft 31 and connected to the drive unit 61 at a position closer to the lower end (the other end) side of the rotation shaft 31 than the transmission mechanism 33; and a second shaft 72 inserted inside the first shaft 71, arranged coaxially with the first shaft 71, including a connected portion 87 connected to the transmission mechanism 33 at the upper end (the one end) side, and configured to rotate together with the first shaft 71. The lubricating oil passage 96 includes: a first helical passage 81 formed in the first shaft 71 and extending helically about a rotation axis of the rotation shaft 31; and a second helical passage 90 formed in the second shaft 72 and extending helically about the rotation axis of the rotation shaft 31. The first helical passage 81 includes, in the first shaft 71, a first inlet 81A formed between the transmission mechanism 33 and the drive unit 61, and a first outlet 81B formed on the lower end (the other end) side, and is configured to feed the lubricating oil L that has flowed into the first inlet 81A according to rotation of the first shaft 71 to the first outlet 81B. The second helical passage 90 includes a second inlet 90A formed on the lower end (the other end) side of the rotation shaft 31 and a second outlet 90B formed in the connected portion 87, and is configured to feed the lubricating oil L that has flowed into the second inlet 90A according to the rotation of the second shaft 72 to the second outlet 90B.

According to this aspect, the second outlet 90B of the second helical passage 90 is provided in the connected portion 87 connected to the transmission mechanism 33. Accordingly, the lubricating oil L that has flowed out from the second outlet 90B can lubricate and cool the transmission mechanism 33. Further, since the first helical passage 81 is formed on the first shaft 71 connected to the drive unit 61 of the electric motor 32, the heat transferred from the drive unit 61 of the electric motor 32 to the first shaft 71 is cooled by the lubricating oil L flowing through the first helical passage 81. Accordingly, the lubricating oil L flowing through the first helical passage 81 can cool the drive unit 61 of the electric motor 32. Further, since the first helical passage 81 and the second helical passage 90 are formed on the rotation shaft 31, the lubricating oil passage 96 can be made compact. Accordingly, the electric drive device 10 can lubricate the transmission mechanism 33 and cool the electric motor 32 using the compact lubricating oil passage 96. Accordingly, the electric drive device 10 includes the electric motor 32 and the transmission mechanism 33, and can achieve both cooling of the electric motor 32 and the transmission mechanism 33 and compactness.

In the above aspect, preferably, the lubricating oil passage 96 includes a first storage space 96A connected to the first outlet 81B of the first helical passage 81 and the second inlet 90A of the second helical passage 90, and storing the lubricating oil L, and the second inlet 90A is immersed in the lubricating oil L stored in the first storage space 96A.

According to this aspect, the lubricating oil L that has flowed out from the first outlet 81B is stored in the first storage space 96A. Since the second inlet 90A is immersed in the lubricating oil L stored in the first storage space 96A, the lubricating oil L readily flows into the second inlet 90A. Further, the flow rate of the lubricating oil L flowing through the second helical passage 90 can be increased. Accordingly, the flow rate of the lubricating oil L that flows out from the second outlet 90B and lubricates the transmission mechanism 33 increases, so that the lubricating oil L can reliably lubricate the transmission mechanism 33.

In the above aspect, preferably, the first outlet 81B is arranged higher than an oil level OL1 of the lubricating oil L stored in the first storage space 96A.

According to this aspect, the first outlet 81B is arranged higher than the oil level OL1 of the lubricating oil L stored in the first storage space 96A, and is not immersed in the lubricating oil L. Thereby, the lubricating oil L flows out from the first outlet 81B of the first helical passage 81 more readily than when the first outlet 81B is immersed in the lubricating oil L stored in the first storage space 96A. Accordingly, the flow rate of the lubricating oil L flowing through the first helical passage 81 can be increased. Accordingly, the lubricating oil L flowing through the first helical passage 81 can reliably cool the electric motor 32.

In the above aspect, preferably, the first storage space 96A is arranged at a bottom of the case 15, and the bottom of the case 15 is provided with the second cooling passage 58 (cooling passage) through which a refrigerant flows.

According to this aspect, the lubricating oil L stored in the first storage space 96A is cooled by the refrigerant flowing through the second cooling passage 58 (cooling passage). The lubricating oil L cools the electric motor 32 and the transmission mechanism 33. Accordingly, the lubricating oil L can more reliably cool the electric motor 32 and the transmission mechanism 33.

In the above aspect, preferably, the first storage space 96A is arranged at a bottom of the case 15, and the case 15 includes a plurality of helical raised walls 57 extending upward from the bottom and extending radially outward of the rotation axis and helically about the rotation axis from an outer circumference of the second shaft 72.

According to this aspect, the helical raised walls 57 are provided around the second inlet 90A. The helical raised walls 57 prevent the lubricating oil L from flowing radially outward from the second inlet 90A. Thereby, the lubricating oil L readily flows into the second inlet 90A. Accordingly, the flow rate of the lubricating oil L flowing through the second helical passage 90 can be increased. Accordingly, the lubricating oil L can reliably lubricate and cool the transmission mechanism 33.

In the above aspect, preferably, the electric motor 32 is arranged below the transmission mechanism 33, the lubricating oil passage 96 includes a second storage space 96B connected to the first inlet 81A of the first helical passage 81 and storing the lubricating oil L, and the first inlet 81A is immersed in the lubricating oil L stored in the second storage space 96B.

According to this aspect, the first inlet 81A is immersed in the lubricating oil L stored in the second storage space 96B. Thereby, the lubricating oil L stored in the second storage space 96B readily flows into the first helical passage 81 from the first inlet 81A. Accordingly, the flow rate of the lubricating oil L flowing through the first helical passage 81 can be increased. Accordingly, the lubricating oil L flowing through the first helical passage 81 can reliably cool the electric motor 32.

In the above aspect, preferably, a second storage space 96B is defined by a bottom surface (46A) that inclines downward toward a radially inner side.

According to this aspect, the inclined bottom surface (46A) facilitates the accumulation of the lubricating oil L stored in the second storage space 96B at the first inlet 81A arranged on the radially inner side of the second storage space 96B. Thereby, the lubricating oil L stored in the second storage space 96B readily flows into the first helical passage 81 from the first inlet 81A. Accordingly, the flow rate of the lubricating oil L flowing through the first helical passage 81 can be increased. Accordingly, the lubricating oil L flowing through the first helical passage 81 can reliably cool the electric motor 32.

In the above aspect, preferably, the first helical passage 81 extends helically in the left-handed direction (one of a right-handed direction and a left-handed direction), and the second helical passage 90 extends helically in the right-handed direction (the other of the right-handed direction and the left-handed direction).

According to this aspect, the first helical passage 81 can be formed so as to reliably feed the lubricating oil L that has flowed from the first inlet 81A to the first outlet 81B, and the second helical passage 90 can be formed so as to reliably feed the lubricating oil L that has flowed from the second inlet 90A to the second outlet 90B.

In the above aspect, preferably, the transmission mechanism 33 is a planetary gear mechanism including: a sun gear 91 arranged in the connected portion 87 of the second shaft 72; a plurality of planetary gears 92 meshed with the sun gear 91; a planetary carrier 93 rotatably supporting the plurality of planetary gears 92; and a ring gear 94 meshed with the plurality of planetary gears 92.

According to this aspect, since the transmission mechanism 33 is the planetary gear mechanism, the length of the transmission mechanism 33 in the axial direction X can be shortened. Accordingly, the electric drive device 10 can be made compact.

1. An electric drive device comprising:
an electric motor including a rotation shaft and a drive unit configured to drive the rotation shaft;
a drive shaft;
a transmission mechanism connected to one end side of the rotation shaft and to the drive shaft and configured to transmit an output torque of the electric motor from the rotation shaft to the drive shaft;
a case; and
a lubricating oil passage provided in the case and through which lubricating oil flows, wherein
the rotation shaft includes:
a first shaft formed in a hollow tubular shape extending in an axial direction of the rotation shaft and connected to the drive unit at a position closer to the other end side of the rotation shaft than the transmission mechanism; and
a second shaft inserted inside the first shaft, arranged coaxially with the first shaft, including a connected portion connected to the transmission mechanism at the one end side, and configured to rotate together with the first shaft,
the lubricating oil passage includes:
a first helical passage formed in the first shaft and extending helically about a rotation axis of the rotation shaft; and
a second helical passage formed in the second shaft and extending helically about the rotation axis of the rotation shaft,
the first helical passage includes, in the first shaft, a first inlet formed between the transmission mechanism and the drive unit, and a first outlet formed on the other end side, and is configured to feed the lubricating oil that has flowed into the first inlet according to rotation of the first shaft to the first outlet, and
the second helical passage includes a second inlet formed on the other end side of the rotation shaft and a second outlet formed in the connected portion, and is configured to feed the lubricating oil that has flowed into the second inlet according to the rotation of the second shaft to the second outlet.

2. The electric drive device according to claim 1, wherein the lubricating oil passage includes a first storage space connected to the first outlet of the first helical passage and the second inlet of the second helical passage, and storing the lubricating oil, and
the second inlet is immersed in the lubricating oil stored in the first storage space.

3. The electric drive device according to claim 2, wherein the first outlet is arranged higher than an oil level of the lubricating oil stored in the first storage space.

4. The electric drive device according to claim 2, wherein the first storage space is arranged at a bottom of the case, and
the bottom of the case is provided with a cooling passage through which a refrigerant flows.

5. The electric drive device according to claim 2, wherein the first storage space is arranged at a bottom of the case, and
the case includes a plurality of helical raised walls extending upward from the bottom and extending radially outward of the rotation axis and helically about the rotation axis from an outer circumference of the second shaft.

6. The electric drive device according to claim 1, wherein the electric motor is arranged below the transmission mechanism,
the lubricating oil passage includes a second storage space connected to the first inlet of the first helical passage and storing the lubricating oil, and
the first inlet is immersed in the lubricating oil stored in the second storage space.

7. The electric drive device according to claim 6, wherein the second storage space is defined by a bottom surface that inclines downward toward a radially inner side.

8. The electric drive device according to claim 1, wherein the first helical passage extends helically in one of a right-handed direction and a left-handed direction, and
the second helical passage extends helically in the other of the right-handed direction and the left-handed direction.

9. The electric drive device according to claim 1, wherein the transmission mechanism is a planetary gear mechanism including:
a sun gear arranged in the connected portion of the second shaft;
a plurality of planetary gears meshed with the sun gear;
a planetary carrier rotatably supporting the plurality of planetary gears; and
a ring gear meshed with the plurality of planetary gears.
